(19) United States
(12) Patent Application Publication
(10) Pub. No.: US 2015/0001206 A1
(43) Pub. Date: Jan. 1, 2015

(54) ELECTRIC CARTRIDGE TYPE HEATER AND METHOD FOR MANUFACTURING SAME

(71) Applicant: Tuerk & Hillinger GmbH, Tuttlingen (DE)

(72) Inventor: Andreas SCHLIPF, Tuttlingen (DE)

(21) Appl. No.: 14/313,204

(22) Filed: Jun. 24, 2014

(30) Foreign Application Priority Data
Jun. 26, 2013 (DE) 10 2013 212 205.5

(51) Int. Cl. H05B 3/44; H01C 17/28; H01C 17/04; H05B 3/06; H01C 17/02

(52) U.S. Cl. CPC H05B 3/44; H05B 3/06; H01C 17/02; H01C 17/04; H01C 17/28
USPC 219/534; 219/536; 219/541; 219/544; 29/611; 29/618

(57) ABSTRACT

An electric cartridge type heater (100, 200, 300, 400, 500, 600, 700, 800, 900, 1000) has at least one the tubular metallic jacket (101, 201, 301, 401, 501, 601, 701, 801, 901, 1001), at least one electric heat conductor (102, 202, 302, 402, 502, 602, 702, 802, 902, 1002) arranged in the interior space of the tubular metallic jacket with two ends for electrically contacting the electric heat conductor, wherein the at least one electric heat conductor is electrically isolated from the tubular metallic jacket by an electrically insulating material (103, 203, 303, 403, 503, 603, 703, 903) arranged in the interior space of the tubular metallic jacket (101, 201, 301, 401, 501, 601, 701, 801, 901, 1001). The electric heat conductor is self-supporting. A method is also provided for manufacturing such an electric cartridge type heater.

### CROSS REFERENCE TO RELATED APPLICATIONS

This application claims the benefit of priority under 35 U.S.C. §119 of German Patent Application DE 10 2013 212 205.5 filed Jun. 26, 2013, the entire contents of which are incorporated herein by reference.

### FIELD OF THE INVENTION

The present invention pertains to an electric cartridge type heater having least one first tubular metallic jacket, at least one electric heat conductor arranged in the interior of the first tubular metallic jacket, with two ends for electrically contacting the electric heat conductor, wherein the at least one electric heat conductor is electrically insulated from the first tubular metallic jacket by an electrically insulating material arranged in the interior of the first tubular metallic jacket, and the present invention further pertains to a method for manufacturing an electric cartridge type heater.

### BACKGROUND OF THE INVENTION

Electric cartridge type heaters have been known for many years. They usually have at least one metallic jacket, in the interior space of which at least one heat conductor is arranged, wherein an undesired electric contact between the heat conductor and the metallic jacket is prevented by the space between the metallic jacket and the heat conductor being filled at least partially with an electrically insulating material having good thermal conductivity, e.g., magnesium oxide. Electric cartridge type heaters also comprise, in particular, variants with an inner metallic jacket and an outer metallic jacket, often in the form of concentrically arranged tubes, between which the at least one heat conductor is arranged, so that an electric cartridge type heater designed in this manner can be pushed over an object to be heated.

It should be noted, furthermore, that an electric ballast resistor has a design identical to that of an electric cartridge type heater and an electric ballast resistor therefore also represents an electric cartridge type heater in the sense of this invention.

Different embodiments of such electric cartridge type heaters are known, in principle, especially those in which the electric contacting takes place from both sides, and those in which the electric contacting takes place from one side.

Electric cartridge type heaters have hitherto been manufactured mainly according to two different methods.

The Oakley principle is frequently used especially in electric cartridge type heaters in which the electric contacting takes place from both sides. The heat conductor, which is usually coiled tightly, pulled forward or sometimes also prestressed, is inserted into the jacket tube and clamped with its ends in pulling rods, so that the individual coils of the heat conductor are brought to spaced locations from one another. A filling tube is now pushed within the jacket tube over the heat conductor, which ensures that there can be no electric contact between the heat conductor and the jacket tube. When the usually powdered or granular electrically insulating material is filling in, the filling tube can then be pulled out of the jacket tube slowly while shaking, which causes the powdered or granular electrically insulating material to fill the volume released by the filling tube during pulling in just as the space between the coils, so that a sufficient insulation resistance and high-voltage resistance is guaranteed between the heat conductor and the metallic jacket or between two coils of the heat conductor.

The direct application of this principle is not possible in case of electric cartridge type heaters in which the electric contacting is to take place from one side, only because it presupposes that the heat conductor can be mechanically stressed during the filling of the electric cartridge type heater with the insulating material. This applies to high-performance cartridge type heaters, in which high power densities must be reached, so that very short distances from the outer wall and very small coil pitches are important.

To guarantee the desired course of the heat conductor, a carrier structure is therefore used, which provides the opposing forces to the acting mechanical stress, for example, in the form of a coil body usually manufactured from ceramic, or a carrier structure is used, which holds the end of the heat conductor located farthest away from the connection side, so that a mechanical stress, e.g., due to pulling rods, can be built up against this holding point, which stress is necessary to produce a coil structure coiled with spaces and to maintain the coils at spaced locations from one another, i.e., to avoid variations in spacing or short circuits between the individual coils.

However, it is seen in practice that the arrangement of the heat conductor on a coil body or such a carrier structure entails a great effort in terms of manufacturing technology and is susceptible to problems and is expensive.

These problems can be explained especially well for the case in which low-ohmic resistors must be obtained for the application for which the electric cartridge type heater is intended, which is frequently the case in case of relatively long electric cartridge type heaters.

In principle, a lower resistance is known to be able to be achieved by increasing the cross section of the hot wire. However, this leads not only to problems if a reduced space is required for construction, but also to stronger forces to be applied when feeding and removing the coil body into and from the coiling machine and when inserting and tightening the heat conductor in the hole of the coil body, which may even lead to breakage of the coil body in case of porous ceramic coil bodies and if automated coiling is employed, it reduces the speed with which the coiling machine can be operated and thus lowers the output or requires the simultaneous use of a larger number of expensive coil body coiling machines.

As an alternative, it is possible to change over to heat conductors with a lower resistivity, for example, by using CuNi44 instead of NiCr8020. However, this massively reduces the service life of the electric cartridge type heaters and the loadability of the ballast resistors.

The consequence of these problems in practice is usually that several individual resistors with higher resistance values coiled on coil bodies are manufactured and connected in parallel to achieve lower resistances in order to make it possible to avoid compromises in terms of both the cross section and the resistivity of the heat conductor. However, this also leads to a great effort, because a larger number of electric contact points must be provided and centering pieces must often be provided between the coil bodies to guarantee accurate positioning. In addition, any additional electric contact implies an additional risk of the electric cartridge type heater not functioning corresponding to the specifications, especially in case of low-voltage applications, because even low contact resistances may lead to interruptions.

### SUMMARY OF THE INVENTION

An object of the present invention is therefore to provide an improved, especially more reliable, simpler and more cost-effective electric cartridge type heater and a method for manufacturing same.

The electric cartridge type heater according to the present invention has at least one tubular metallic jacket and at least one electric heat conductor arranged in the interior space of the tube that is enclosed by this [metallic jacket] with two ends for electrically contacting the electric heat conductor. The at least one electric heat conductor is electrically insulated from the tubular metallic jacket by an electrically insulating material arranged in the interior of the tubular metallic jacket. The two ends of the at least one electric heat conductor or electric connection means, which are in electric connection with the two ends of the at least one electric heat conductor, or one end of the electric heat conductor and a connection means, which is in electric connection with the other end of the electric heat conductor, may be lead out of the metallic jacket on the same side of said tubular metallic jacket, but a bilateral contacting, led out radially or tangentially, also likewise possible as well, especially also in the middle of the cartridge type heater. Such connection means may be designed, e.g., as a connecting wire, connecting tube, pigtail or connecting bolt, which are soldered, welded or pressed to the end of the electric heat conductor.

It is a feature according to the present invention that the electric heat conductor is self-supporting. The word “self-supporting” means here at least that the minimum distances from one coil to the next are guaranteed by the internal stress, but no mechanical stresses of the heat conductor are preferably provided or maintained by further components of the electric cartridge type heater in the installed state in the cartridge type heater and, in particular, no carrier structure has to be present for absorbing such stresses.

Whether or not an electric heat conductor is self-supporting in the above-mentioned preferred sense can be checked simply by determining whether the course and/or shape of the heat conductor changes when the cartridge type heater is removed and especially the insulating material surrounding the heat conductor and a carrier structure that may possibly be present are removed or destroyed. It appears from this that the term “dimensionally stable” more accurately “dimensionally stable in case of removal of the heat conductor from the cartridge type heater” could also be used alternatively to the term “self-supporting.” The electric heat conductor is thus provided in a preformed state and already brought to the desired shape without carrier structure.

It should be noted, in particular, that these conditions are also met even if the heat conductor was re-stressed in the built-in state.

It becomes possible with the embodiment of the heat conductor, according to the present invention, to achieve a marked improvement of the attainable tolerances concerning cylindrical shape, coaxiality, concentricity, which may be especially below 1 mm and preferably below 0.5 mm, for coiled heat conductors.

The use of a self-supporting heat conductor makes it possible to simply insert the preformed heat conductor brought to the desired shape into the jacket tube during the manufacture and to surround it with insulating material, which simplifies the manufacturing process and leads to significant cost savings. Rejects due to breakage of the angle body and possibly loss of time due to a possible reduction of the speed of coiling to avoid such breakage are reliably avoided.

Further advantages are that the self-supporting heat conductor makes it possible in a reliable manner to carry out coiling with very small pitches or very short distances between the coils and to reliably offer a short distance between the heat conductor and the tubular metallic jacket. Both are essential for the best possible heat transport to the tubular metallic jacket and a low surface load of the heat conductor.

To increase the reliability of the process during the manufacture of the electric cartridge type heater, it is advantageous for at least one positioning element to be provided, optionally under axial stress or axial pressure on the heating coil, for fixing the position of the heat conductor in a defined manner in the interior of the tubular metallic jacket. In particular, the desired distance between the heating element and the tubular metallic jacket can thus be set accurately. It thus becomes possible, especially in case of coiled heat conductors, that the distance between the electric heat conductor and the tubular metallic jacket is smaller than 1.5 mm and especially smaller than 1 mm.

A second tubular metallic jacket is arranged concentrically to the first tubular metallic jacket in the interior space of the latter in an advantageous embodiment of the present invention, so that the self-supporting electric heat conductor is arranged between the first and second tubular metallic jackets. A cartridge type heater that can enclose a component to be heated can thus be provided.

It should be noted, in particular, that hollow cartridges of a corresponding design with inner metallic jacket and outer metallic jacket, which may also be made in one piece with a bottom connecting them, or ballast resistors having this design can also be considered to be an electric cartridge type heater in the sense of the present invention.

In a variant of the electric hollow cartridge thus manufactured, the second tubular metallic jacket has a contoured interior space, i.e., the diameter of the interior space varies in the radial direction, i.e., in a direction at right angles to the direction in which the second tubular metallic jacket extends. An accurately fitting or an at least more accurately fitting enclosing of the component to be heated can be made possible hereby in many cases.

A variant of the present invention that is especially advantageous for hollow cartridges is one in which an electrically insulating material having a thermal conductivity that is worse than the thermal conductivity between the self-supporting electric heat conductor and the tubular metallic jacket is arranged between the first tubular metallic jacket and the self-supporting electric heat conductor. The heat generated shall be preferably removed in the direction of the interior space of the hollow cartridge in electric hollow cartridges in order to heat the component to be heated, over which the hollow cartridge is pushed, which is achieved by this measure.

In a preferred variant of the present invention, the electric cartridge type heater has at least one spacer, which makes it possible to arrange the heat conductor in the tubular metallic jacket in a reproducible manner. In particular, the heat conductor may be arranged such that is coiled around this, because it is possible to push the spacer into the self-supporting heat conductor in a controlled manner after the heat conductor has been formed. Contrary to the carrier structures of usual heat conductors, such a spacer has no structure with which a mechanical stress of the heat conductor is maintained. It is, of course, also possible as an alternative or in addition to provide spacers to a second tubular metallic jacket that may possibly be provided.

It is advantageous, furthermore, if the spacer has a hole, through which the heat conductor is led, because an unintended contact between different sections of the heat conductor is avoided hereby.

Another advantage of the electric cartridge type heater according to the present invention is that depending on the application, a plurality of different embodiments of the course of the heat conductor are possible, which can otherwise often be embodied with very great difficulty only.

A geometric arrangement of the heat conductor makes provisions for the heat conductor to have a section leading away from the connection-side end face of the electric cartridge type heater and a section that is conductively connected with that section and leads back to the connection-side end face, wherein these sections of the heat conductor are designed such that they are coiled around one another.

Another possible geometric arrangement of the heat conductor is designed such that the heat conductor extends in a coiled form and that one end of the heat conductor of a section of the electric connection means extends in the space enclosed by the coils to the connection-side end face of the electric cartridge type heater.

As an alternative hereto, the first, outer metallic jacket may also be used as a return conductor in some applications if one end of the self-supporting heat conductor is connected, preferably inside, with the first, outer metallic jacket.

Finally, a bifilar coiling of the self-supporting heat conductor is also possible, which may be advantageous when the lowest possible inductivity of the arrangement is desired.

It is possible in coiled heat conductors that the heat conductor has different coil pitches to provide different power densities.

It becomes possible with the self-supporting heat conductors according to the present invention that the pitch of the heat conductor corresponds to a maximum of 3 times the diameter of the heat conductor, especially to 2.5 times and preferably to 2 times the diameter of the heat conductor in the area coiled to the smallest pitch.

Finally, a meandering course of the heat conductor may be provided as well.

One possible distinctive feature from prior-art electric cartridge type heaters with coil bodies, on which the heating element is coiled under mechanical stress, is that the two ends of the electric heat conductor point in the same direction.

It is advantageous in all exemplary embodiments discussed above if the entire structure is compacted, especially compacted by reducing the cross section.

It is preferable, furthermore, that the cross section of the self-supporting electric heat conductor has a smaller extension when viewed in the axial direction of the cartridge type heater than when viewed in the axial direction of the cartridge type heater. A heat conductor that is approximated to the geometry of flat wires that cannot otherwise be used for this application is thus provided.

The method according to the present invention for manufacturing an electric cartridge type heater has at least the following steps: Provision of at least a first tubular metallic jacket; deformation of a self-supporting heat conductor, so that it describes a preset curve in the space in a dimensionally stable manner, which said curve is arranged in an interior space of the first tubular metallic jacket; arrangement of the deformed self-supporting heat conductor in the interior space of the first tubular metallic jacket; and embedding of the deformed self-supporting heat conductor in at least one electrically insulating material, so that an electric contact is avoided between sections of the preset curve in the space, which curve is described by the preformed self-supporting heat conductor, and both other sections of the deformed self-supporting heat conductor and the first tubular metallic jacket and further metallic jackets, if present.

The sequence of the steps is variable especially in respect to the first two steps.

The deformation of the self-supporting heat conductor can be achieved concretely, for example, by the self-supporting heat conductor being coiled on a mandrel. However, other common manufacturing methods for manufacturing springs may generally be considered as well for bringing about the desired deformation.

Provisions are made in an especially advantageous variant of the method for changing the cross section of the self-supporting heat conductor by pressing, especially making thinner in directions that correspond to a radial direction of the metallic jacket after insertion into the tubular metallic jacket, after the deformation of the self-supporting heat conductor to the preset curve in the space, preferably before the deformed self-supporting heat conductor is arranged in the interior space of the first tubular metallic jacket. The structural shape can be made especially compact in this manner.

It is especially preferred to provide a second tubular metallic jacket and to arrange it concentrically to the first tubular metallic jacket in the interior space of the first tubular metallic jacket and, furthermore, to arrange it within the three-dimensional curve described by the self-supporting heat conductor, so that the second metallic jacket is surrounded by at least one section of the self-supporting heat conductor when viewed in any radial direction of the metallic jacket, so that an electric hollow cartridge is produced. In particular, the second metallic jacket may be connected with the first metallic jacket, either via a bottom disk to be fitted separately or also via a direct connection, which may also be made in one piece, and it is especially also possible and advantageous to form the outer metallic jacket, inner metallic jacket and bottom piece from one piece of metal.

The product manufactured with the method is further improved by an arrangement comprising at least the first tubular metallic jacket, the second tubular metallic jacket and the self-supporting heat conductor arranged therein being arranged on a contoured mandrel and pressed radially, so that at least the diameter of the interior space of the second tubular metallic jacket will vary over the extension thereof. In particular, a conical or stepped course of the interior space of the second tubular metallic jacket can thus be embodied. A possibility can be created in this manner for also heating a component with a more complex surface shape with an accurately fitting hollow cartridge.

The present invention will be explained in more detail below on the basis of figures, which show different exemplary embodiments of the present invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1a is sectional view showing a first exemplary embodiment of an electric cartridge type heater with the metallic jacket cut open and with the electrically insulating material partially removed;

FIG. 1b is a perspective view showing a heat conductor assembly unit of the exemplary embodiment from FIG. 1a;

FIG. 1c is a perspective view showing a variant of the heat conductor assembly unit, which can be used in the exemplary embodiment from FIG. 1a;

FIG. 2a is sectional view showing a second exemplary embodiment of an electric cartridge type heater with the metallic jacket cut open and with the electrically insulating material partially removed;

FIG. 2b is a perspective view showing the heat conductor assembly unit of the exemplary embodiment from FIG. 2a;

FIG. 3a is sectional view showing a third exemplary embodiment of an electric cartridge type heater with the metallic jacket cut open and with the electrically insulating material partially removed;

FIG. 3b is a perspective view showing the heat conductor assembly unit according to the exemplary embodiment from FIG. 3a;

FIG. 4a is sectional view showing a fourth exemplary embodiment of an electric cartridge type heater with the metallic jacket cut open and with the electrically insulating material partially removed;

FIG. 4b is a perspective view showing the heat conductor assembly unit according to the exemplary embodiment from FIG. 4a;

FIG. 5a is sectional view showing a fifth exemplary embodiment of an electric cartridge type heater with the metallic jacket cut open and with the electrically insulating material partially removed;

FIG. 5b is a perspective view the heat conductor assembly unit according to the exemplary embodiment shown in FIG. 5a;

FIG. 5c is a perspective view a variant of the heat conductor assembly unit according to the exemplary embodiment shown in FIG. 5a;

FIG. 6a is sectional view showing a sixth exemplary embodiment of an electric cartridge type heater with the metallic jacket cut open and with the electrically insulating material partially removed;

FIG. 6b is a perspective view the heat conductor assembly unit according to the exemplary embodiment shown in FIG. 6a;

FIG. 7a is sectional view showing a seventh exemplary embodiment of an electric cartridge type heater, viewed in the cross section along the direction in which the electric cartridge type heater extends;

FIG. 7b is sectional view showing the exemplary embodiment from FIG. 7a after an additional pressing step;

FIG. 7c is sectional view showing the exemplary embodiment from FIG. 7a after an alternative additional pressing step;

FIG. 8 is an exploded perspective view of an eighth exemplary embodiment of an electric cartridge type heater;

FIG. 9a is sectional view showing a ninth exemplary embodiment of an electric cartridge type heater, viewed in the cross section along the direction in which the electric cartridge type heater extends;

FIG. 9b is a perspective view showing the heat conductor assembly unit according to the exemplary embodiment shown in FIG. 9a;

FIG. 10a is sectional view showing an assembly unit of an electric cartridge type heater before a compaction step;

FIG. 10b is sectional view showing the assembly unit of an electric cartridge type heater from FIG. 10a after a compaction step, which leads to a conical contouring of the interior space; and

FIG. 10c is sectional view showing a variant of the compaction according to FIG. 10b, which leads to a stepped contouring of the interior space.

### DESCRIPTION OF THE PREFERRED EMBODIMENTS

Referring to the drawings in particular, identical components of identical exemplary embodiments are designated by identical reference numbers in all figures. The features illustrated on the basis of individual embodiments can be applied to all other embodiments unless they are in direct conflict with one another.

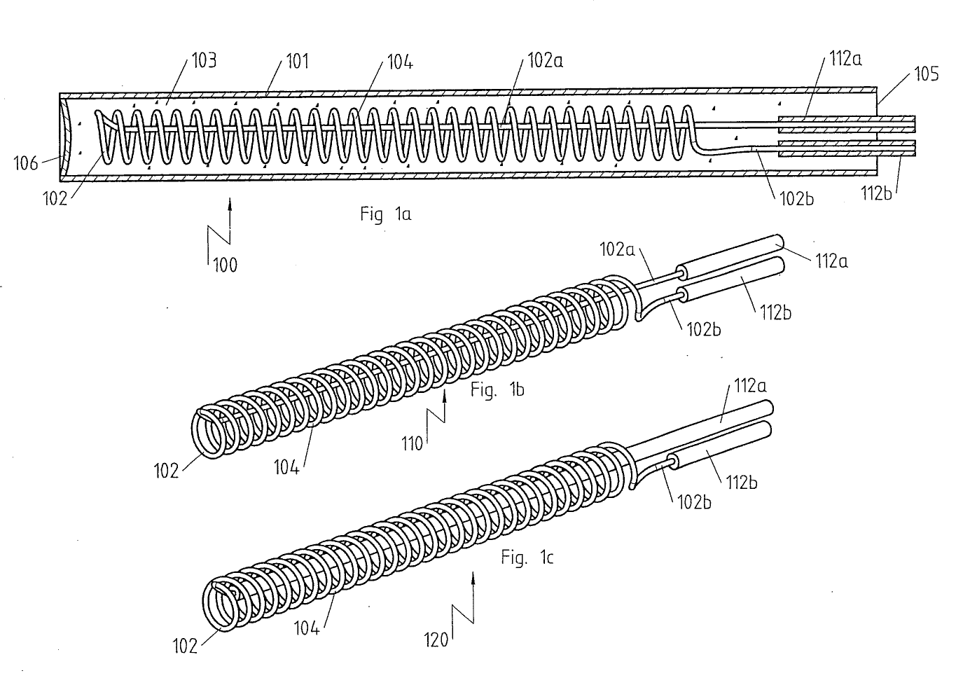

FIG. 1a shows an electric cartridge type heater 100 with a first tubular metallic jacket 101 and with a self-supporting electric heat conductor 102 arranged in the interior tubular space of the first tubular metallic jacket 101 with two ends 102a, 102b for electrically contacting the self-supporting electric heat conductor 102. The self-supporting electric heat conductor 102 is electrically insulated from the first tubular metallic jacket 101 by an electrically insulating material 103, e.g., magnesium oxide, arranged in the interior space of the first tubular metallic jacket 101. The two ends 102a, 102b of the at least one self-supporting electric heat conductor 102 are received in connecting bolts 112a, 112b and are pressed to same. The connecting bolts 112a, 112b are led out of the first tubular metallic jacket 101 on the same side of said metallic jacket, namely, on the end face 105 thereof. A bottom 106, which closes the metallic jacket 101 on the connection-side end face 105, is located opposite that side.

As is best recognized in the view of the heat conductor assembly unit 110 in FIG. 1b, the self-supporting heat conductor 102 extends in a coiled form and the end 102a of the heat conductor 102 extends in the space enclosed by the coils 104 in the direction of the connection-side end face 105 of the electric cartridge type heater 100. The electric heat conductor 102 shown in FIG. 1b is self-supporting, i.e., it only needs to be inserted into the interior space defined by the tubular jacket surface 101 for installation in the electric cartridge type heater 100.

The possibility shown in FIG. 1c is pointed out, in particular, according to which the connecting bolt 112a can be designed in the heat conductor assembly unit 110 such that the contact is established at the end 102a of the heat conductor 102 in the space enclosed by the coils 104, so that a section of the connecting bolt 112a extends in this space. It is possible as a result to reduce the resistance of the electric return.

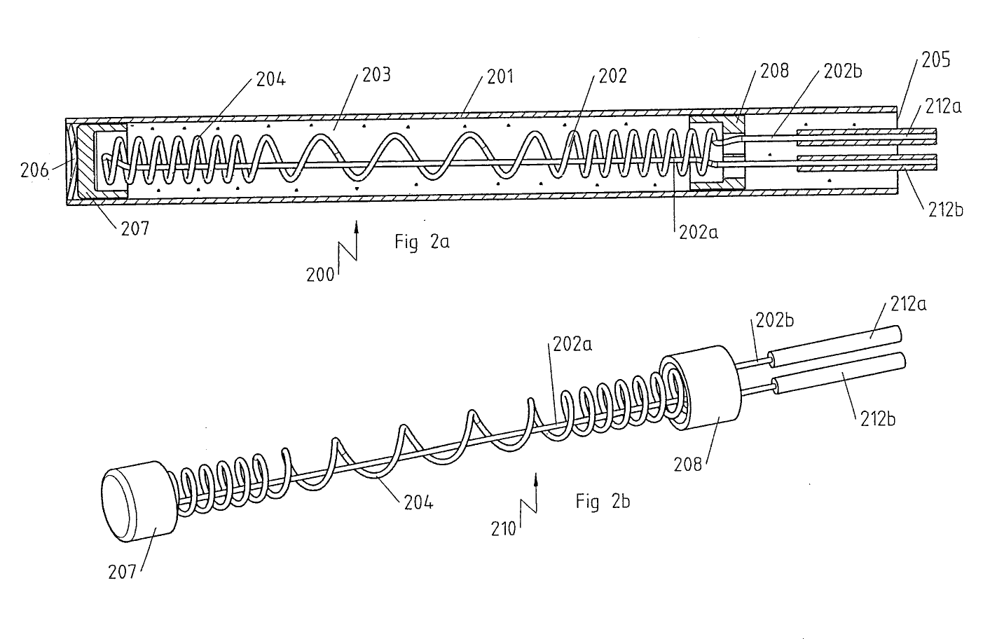

The embodiment of the electric cartridge type heater 200 according to FIGS. 2a and 2b differs from the embodiment according to FIGS. 1a and 1b in that the heat conductor assembly unit 210 shown in FIG. 2b also has two positioning elements 207, 208, which guarantees the reproducible arrangement of the heat conductor assembly unit 210 in the metallic jacket 201. Further, a locally different heat output is achieved due to the variation of the coil pitches.

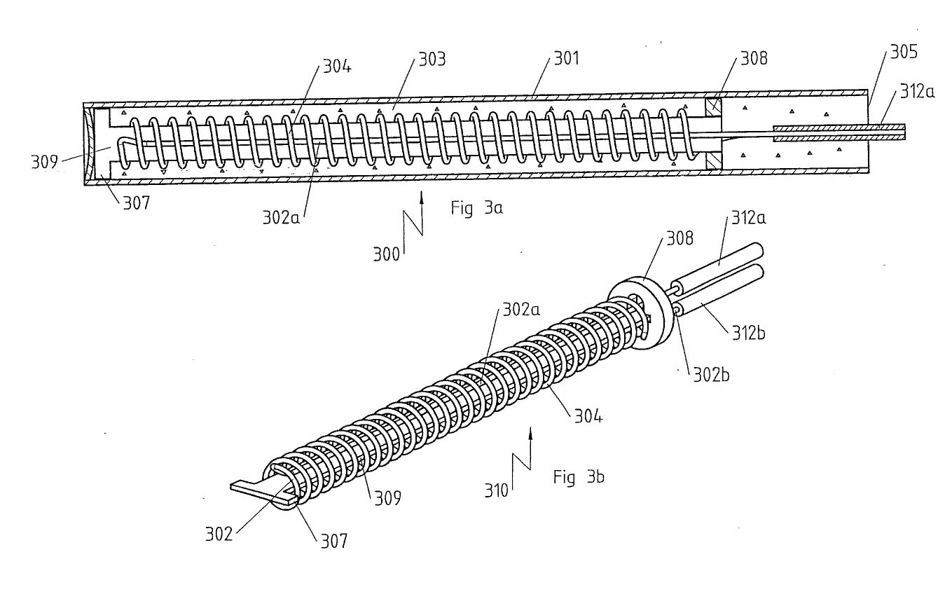

An embodiment of the electric cartridge type heater 300 according to FIGS. 3a and 3b differs from the embodiment according to FIGS. 2a and 2b only in that the heat conductor assembly unit 310 shown in FIG. 3b has a positioning element 307, which is arranged at a spacer 309, which extends through the self-supporting heat conductor 302 and is designed as a rigid carrier. This makes it possible to improve the reproducibility of the assembly, not only in respect to the radial position of the self-supporting heat conductor 302, but also in respect to the longitudinal position of said heat conductor, i.e., the question of how far the self-supporting heat conductor 302 is to be pushed into the first tubular metallic jacket 301.

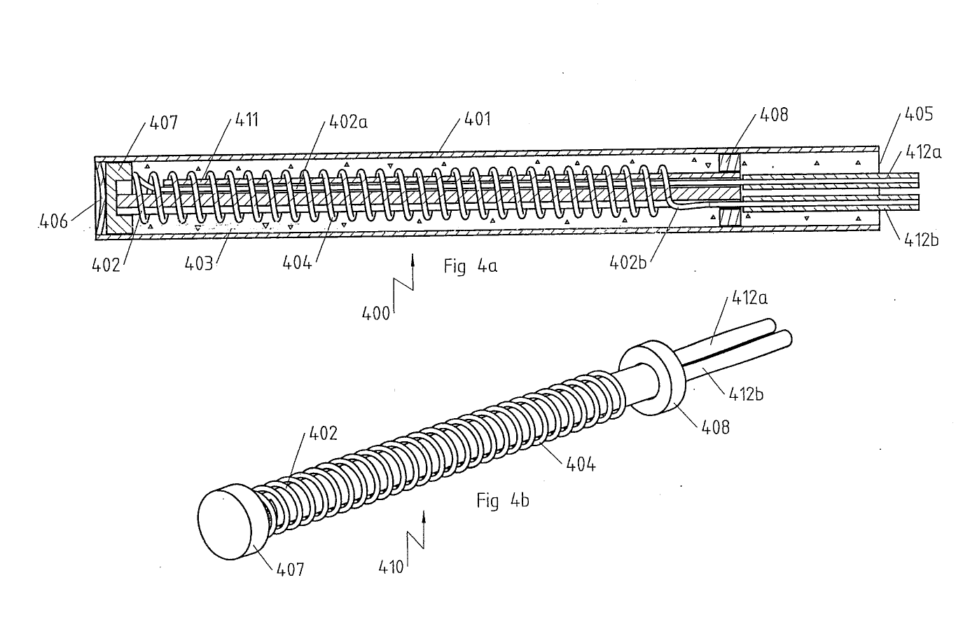

The embodiment of the electric cartridge type heater 400 according to FIGS. 4a and 4b differs from the embodiment according to FIGS. 3a and 3b only in that the spacer 409 has a hole 411, through which the end 402a of the self-supporting heat conductor 402 extends in the space enclosed by the coils 404 to the connection-side end face 405 of the electric cartridge type heater, so that an undesired contact of the end 402a with another part of the self-supporting electric heat conductor 402 is prevented from occurring with certainty.

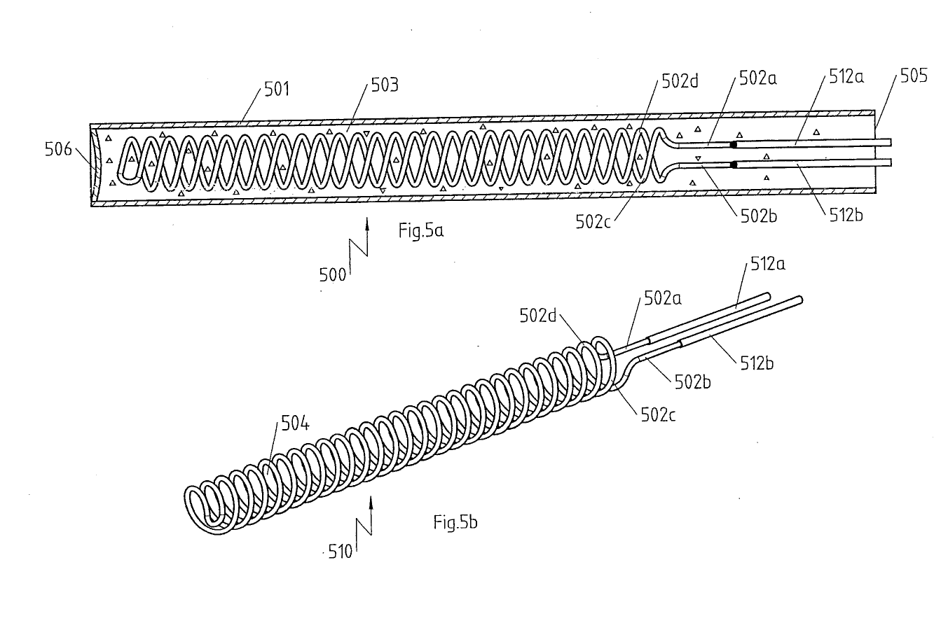

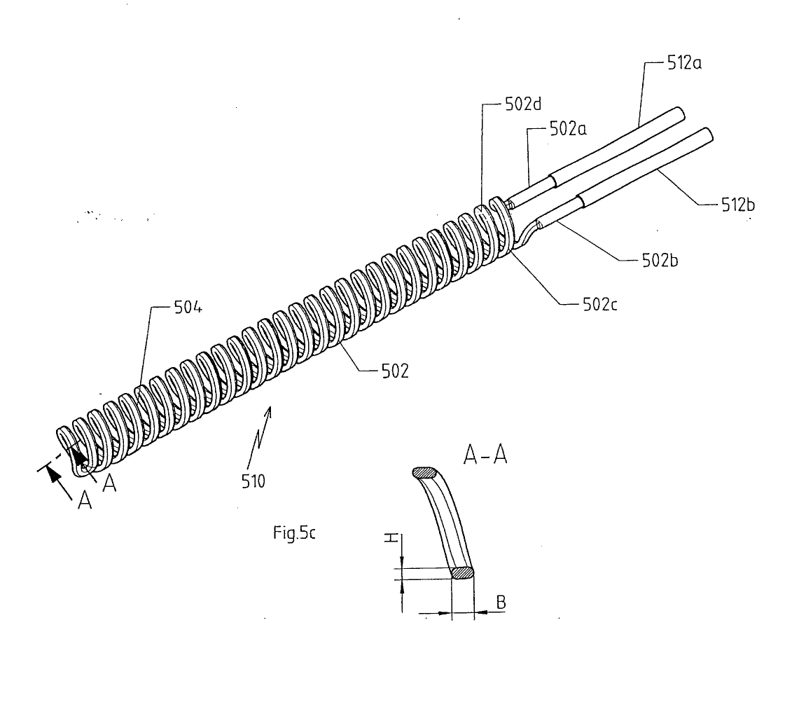

The embodiment of the electric cartridge type heater 500 according to FIGS. 5a and 5b differs from the embodiment according to FIGS. 1a and 1b only in that, as can be best recognized in FIG. 5b, the ends 502a and 502b of the self-supporting heat conductor 502 are soldered to connection wires 512a, 512b and that the self-supporting heat conductor 502 has a section 502c leading away from the connection-side end face 505 of the electric cartridge type heater 500 and a section 502d, which is connected with that section in an electrically conducting manner and leads back to the connection-side end face 505, and these sections of the self-supporting heat conductor 502 are coiled one around the other, i.e., they have a bifilarly coiled design.

FIG. 5c shows a variant of the heat conductor assembly unit according to the exemplary embodiment shown in FIG. 5a, in which a further change was brought about in the cross section of the heat conductor 502 after the deformation of the self-supporting heat conductor 502 into the heat conductor assembly unit shown in FIG. 5b. This is possible, for example, by a rod or a mandrel being pushed into the interior of the heat conductor coils, whose diameter essentially corresponds to the coil diameter, and by subsequently performing a radial pressing. The cross section of the heat conductor 502 is transformed hereby from a round to an oval shape, as a result of which a more compact structural shape becomes possible, in particular.

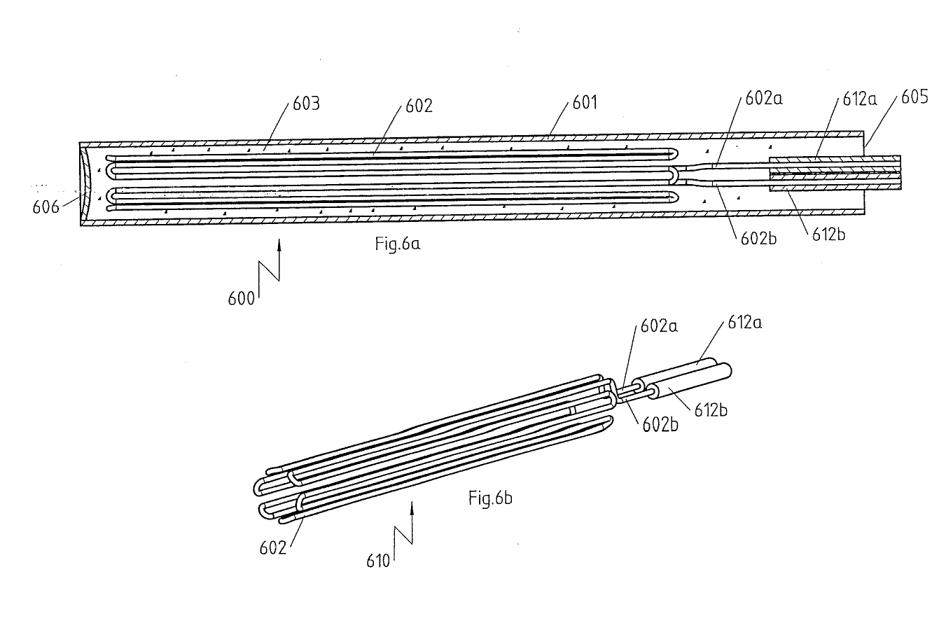

The embodiment of the electric cartridge type heater 600 according to FIGS. 6a and 6b differs from the embodiment according to FIGS. 1a and 1b only in that the heat conductor assembly unit 610 shown in FIG. 6b has a meandering self-supporting electric heat conductor 602.

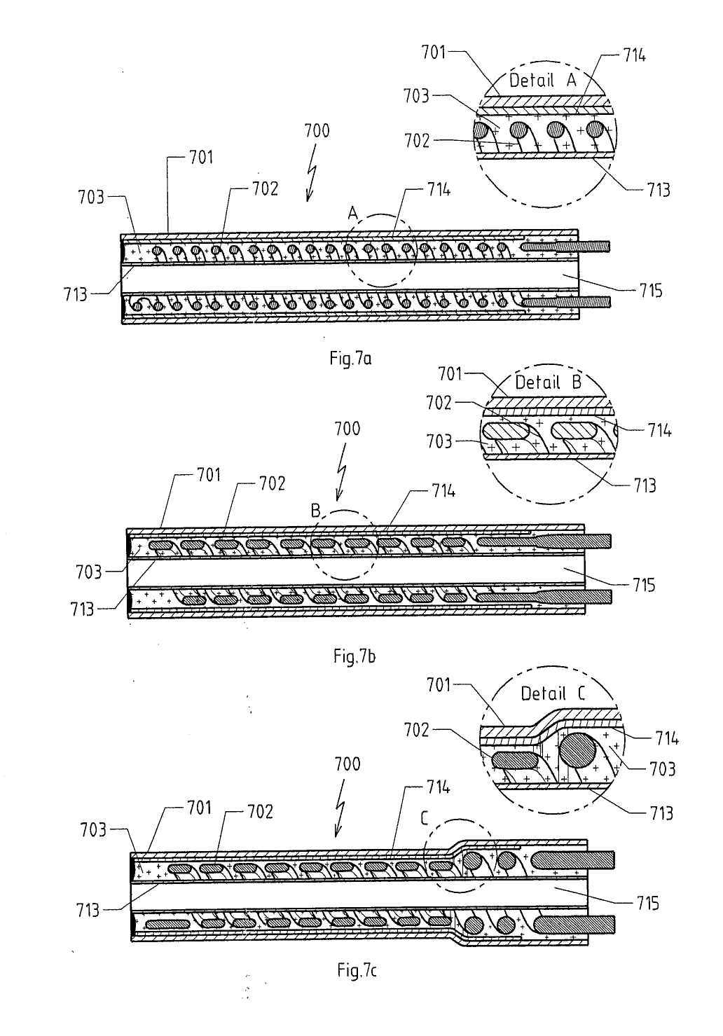

The electric cartridge type heater 700 according to FIG. 7a differs from the electric cartridge type heater 500 according to FIG. 5a above all in that a second, inner tubular metallic jacket 713 is provided, which is arranged concentrically to the first tubular metallic jacket 701 in the interior of the bifilarly coiled self-supporting heat conductor 702, so that a hollow cartridge is formed. Another difference is that a layer 714 consisting of electrically insulating material having a thermal conductivity that is worse than that of the filling material 703, which material contributes to the heat being dissipated preferably in the direction of the interior space 715 of the second, inner tubular metallic jacket 713, is arranged between the first, outer tubular metallic jacket 701 and the bifilarly coiled self-supporting heat conductor 702.

The embodiments of the electric cartridge type heater 700 shown in FIGS. 7b and 7c are obtained by radial pressing over the entire length of the cartridge type heater 700 (as is shown in FIG. 7b) or over a part of the length of the cartridge type heater (as is shown in FIG. 7c). It becomes clear especially when comparing the respective detail views A, B and C belonging to the figures with one another that a deformation of the self-supporting heat conductors 702 is also possible in this step as an alternative or in addition to a deformation of the self-supporting heat conductor 702 before they are inserted into the first, outer tubular metallic jacket 701.

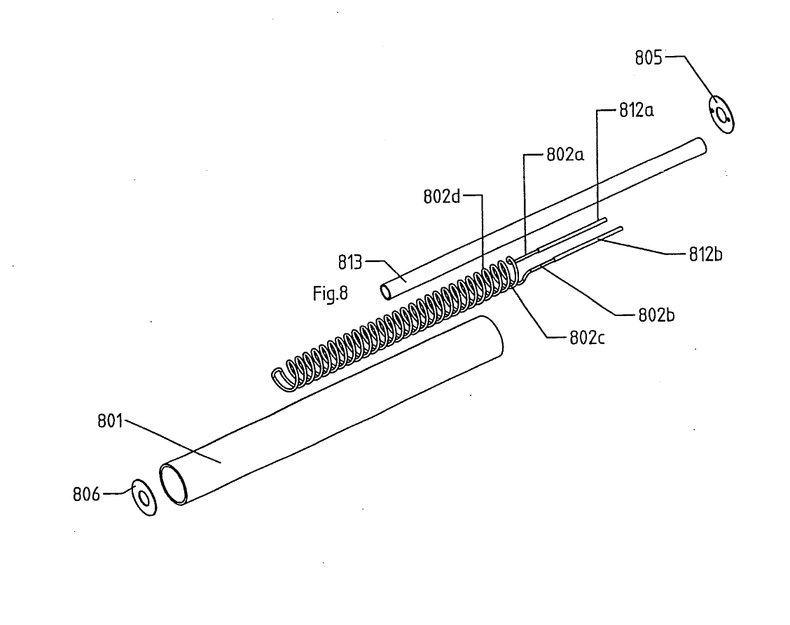

The exemplary embodiment of an electric cartridge type heater 800 shown in FIG. 8 as an exploded view differs from the embodiments shown in FIGS. 7a through 7c only in that no layer 714 is provided. Possible procedures in manufacturing the electric cartridge type heater 800 can easily become clear on the basis of FIG. 8. For example, the self-supporting electric heat conductor 802, which is preformed as a bifilar coil here, can be pushed over the second, inner tubular metallic jacket 813, the end-face end disk 806 can then be connected with the second tubular metallic jacket 813, and the assembly unit thus obtained can be pushed into the first, outer tubular metallic jacket 801. When filling with electric insulating material having good thermal conductivity, e.g., MgO powder, not shown in FIG. 8, the connection-side end face 805 can then be pushed over and fastened, and the entire arrangement can then be compacted radially.

However, it is also possible, as an alternative, to start with the connection of the outer metallic jacket 801 and the end-face end disk 806 and to push subsequently in the self-supporting electric heat conductor 802 preformed as a bifilar coil here. The inner tubular metallic jacket 813 is then pushed into the interior space of the self-supporting electric heat conductor 802, the space between the outer tubular metallic jacket 801 and the inner tubular metallic jacket 813 is filled with electric insulating material having good thermal conductivity, e.g., MgO powder, not shown in FIG. 8, the connection-side end face 805 is pushed over and fastened, and the entire arrangement is finally optionally compacted radially.

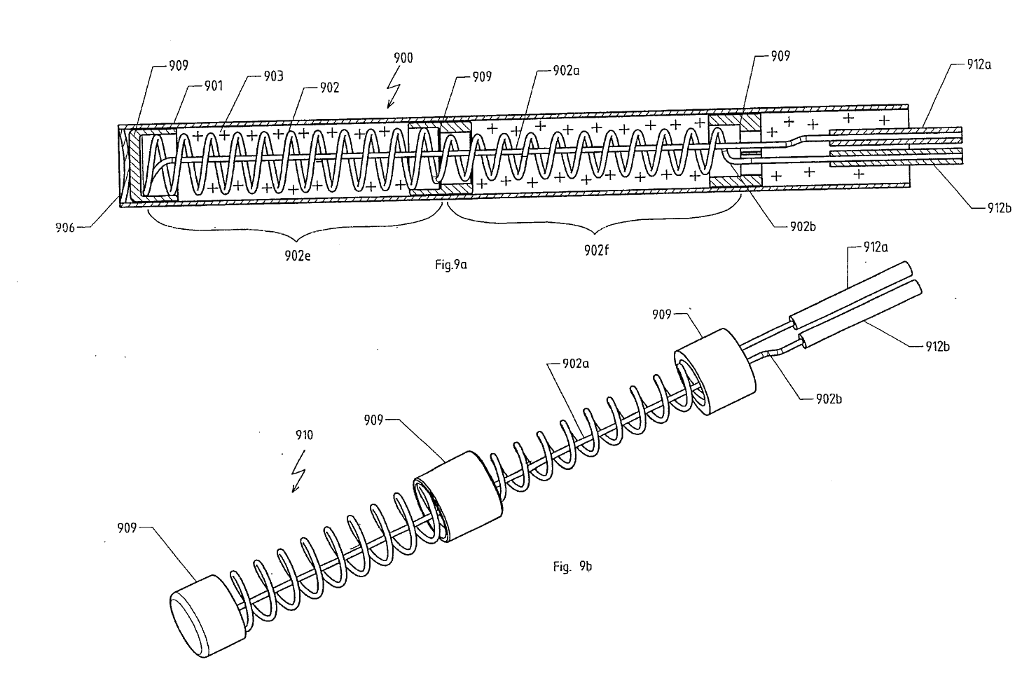

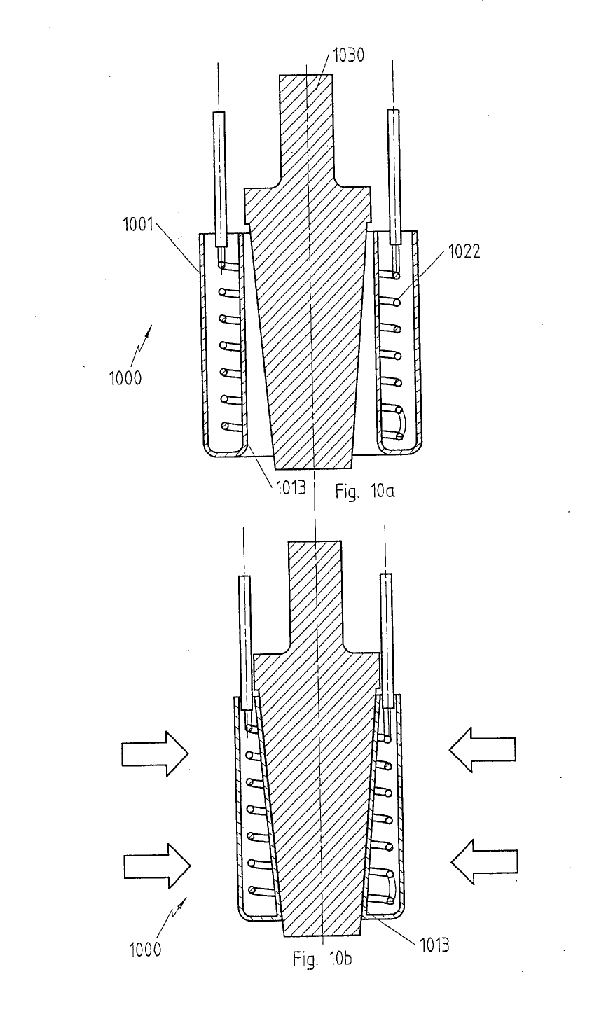

The embodiment of an electric cartridge type heater 900 shown in FIGS. 9a and 9b is a variant of the embodiment according to FIG. 1a, in which areas 902e and 902f of the self-supporting electric heat conductor are provided, which have different coil diameters. It is achieved hereby, in particular, that the middle positioning element, which has a step, is fixed.

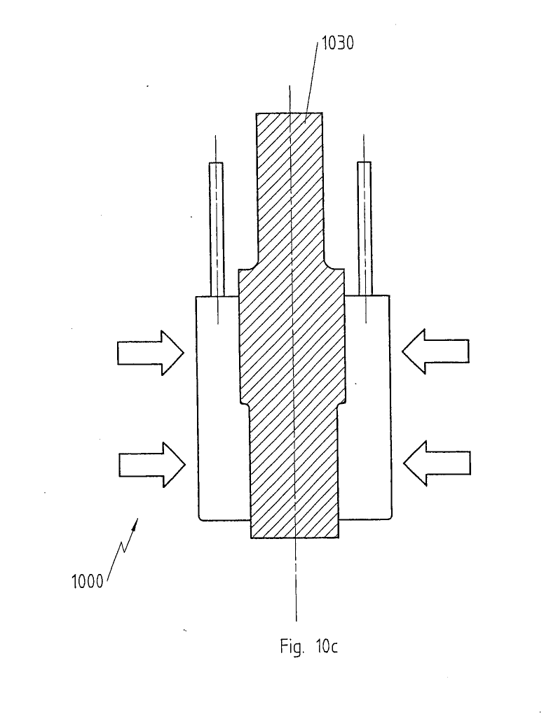

FIGS. 10a through 10c are intended to illustrate a possible procedure for producing an electric cartridge type heater 1000, more precisely a hollow cartridge, whose interior space 1020 has a contour. This procedure is carried out by pressing on a mandrel 1030, which has, on the one hand, the negative of the desired shape, e.g., on a conical mandrel 1030, as is shown in FIG. 10b, or on a stepped mandrel 1030, as is shown in FIG. 10c.

While specific embodiments of the invention have been shown and described in detail to illustrate the application of the principles of the invention, it will be understood that the invention may be embodied otherwise without departing from such principles.

What is claimed is:

1. An electric cartridge type heater comprising:
a tubular metallic jacket;
an electric heat conductor arranged in an interior of the tubular metallic jacket and having contact ends electrically contacting the electric heat conductor, the electric heat conductor being self-supporting; and
an electrically insulating material arranged in the interior of the tubular metallic jacket, wherein the electric heat conductor is electrically insulated from the first tubular metallic jacket by the electrically insulating material.

2. An electric cartridge type heater in accordance with claim 1, further comprising a positioning element provided in the interior of the tubular metallic jacket for a defined fixation of a position of the heat conductor.

3. An electric cartridge type heater in accordance with claim 1, further comprising a another tubular metallic jacket arranged concentrically to the tubular metallic jacket in the interior space thereof, so that the self-supporting electric heat conductor is arranged between the tubular metallic jacket and the another tubular metallic jacket.

4. An electric cartridge type heater in accordance with claim 3, wherein the another tubular metallic jacket has a contoured interior space.

5. An electric cartridge type heater in accordance with claim 3, further comprising additional electrically insulating material having a thermal conductivity that is lower than that of the electrically insulating material between the self-supporting electric heat conductor and the another tubular metallic jacket, the additional electrically insulating material being arranged between the tubular metallic jacket and the self-supporting electric heat conductor.

6. An electric cartridge type heater in accordance with claim 1, further comprising a spacer which makes it possible to arrange the heat conductor reproducibly in the tubular metallic jacket.

7. An electric cartridge type heater in accordance with claim 1, wherein the heat conductor has a section leading away from a connection-side end face of the electric cartridge type heater and another section connected with the section in an electrically conducting manner and leading back to the connection-side end face, wherein the section and the another section of the heat conductor are designed such that they are coiled one around the other.

8. An electric cartridge type heater in accordance with claim 1, wherein the heat conductor extends in a coiled form and contact ends, electrically contacting the heat conductor, or a section of an electric connection means extend in the space enclosed by the coils to a connection-side end face of the electric cartridge type heater.

9. An electric cartridge type heater in accordance with claim 1, wherein a pitch of the heat conductor in the area formed with the smallest pitch corresponds at most to 3 times the diameter of the heat conductor.

10. An electric cartridge type heater in accordance with claim 1, wherein the self-supporting electric heat conductor extends in a meandering pattern.

11. An electric cartridge type heater in accordance with claim 1, wherein the contact ends electrically contacting the heat conductor point in the same direction.

12. An electric cartridge type heater in accordance with claim 1, wherein the electric cartridge type heater is compacted by a reduction of the cross section.

13. An electric cartridge type heater in accordance with claim 1, wherein a cross section of the self-supporting electric heat conductor has a shorter extension in a radial direction than in an axial direction.

14. A method for manufacturing an electric cartridge type heater, the method comprising the steps of:
providing a tubular metallic jacket;
deforming a self-supporting heat conductor, so that it describes a preset curve in space, which curve is arranged in an interior space of the tubular metallic jacket, in a dimensionally stable manner;
arranging the deformed self-supporting heat conductor in the interior space of the tubular metallic jacket; and
embedding the deformed self-supporting heat conductor in an electrically insulating material, so that an electric contact is prevented between sections of the preset curve in the space, which curve is described by the preformed self-supporting heat conductor, and a remainder of the preformed self-supporting heat conductor and the tubular metallic.

15. A method in accordance with claim 14, wherein the self-supporting heat conductor is coiled on a mandrel to deform the self-supporting heat conductor.

16. A method in accordance with claim 14, wherein a cross section of the self-supporting heat conductor is changed by pressing to reduce directions that correspond to a radial direction of the metallic jacket, after insertion the self-supporting heat conductor into the tubular metallic jacket, and after the deformation of the self-supporting heat conductor into the preformed curve in the space and before the preformed self-supporting heat conductor is arranged in the interior space of the tubular metallic jacket.

17. A method in accordance with claim 14, wherein further comprising:
providing a another tubular metallic jacket;
arranging the another tubular metallic jacket concentrically to the tubular metallic jacket further, within the three-dimensional curve described by the self-supporting heat conductor, so that the another metallic jacket is surrounded by at least one section of the self-supporting heat conductor when viewed in any radial direction of the another metallic jacket.

18. A method in accordance with claim 17, wherein an arrangement comprising at least the tubular metallic jacket, the another tubular metallic jacket and the self-supporting heat conductor is arranged on a contoured mandrel and pressed radially, so that at least the diameter of the interior space of the another tubular metallic jacket varies over the extension thereof.
